(19) United States
(12) Patent Application Publication
(10) Pub. No.: US 2015/0277941 A1
(43) Pub. Date: Oct. 1, 2015

(54) METHOD AND SYSTEM FOR LINKING TO SHARED LIBRARY

(71) Applicant: OpenPeak Inc., Boca Raton, FL (US)

(72) Inventors: Andrew James Dobson, McKinney, TX (US); David Medina, Palmetto Bay, FL (US)

(21) Appl. No.: 14/614,866

(22) Filed: Feb. 5, 2015

Related U.S. Application Data
(60) Provisional application No. 61/936,378, filed on Feb. 6, 2014.

(51) Int. Cl. G06F 9/445

(52) U.S. Cl. CPC G06F 9/44521

(57) ABSTRACT

A system and method for linking to a shared library, such as a shared class library, are described herein. The method can include the step of launching an application on a computing device in which the computing device supports a first class loader and a second class loader. The first class loader may serve as a parent class loader to the second class loader. In response to the launching of the application, an override class loader that is configured to serve as an override parent class loader to the second class loader can be generated. When a request for a component is received from the launched application at the second class loader, the request can be intercepted by the override class loader to determine if the override class loader is to process the request. If the override class loader is to process the request, the override class loader can be used to search the shared library for the component.

### CROSS-REFERENCE TO RELATED APPLICATIONS

This patent application claims priority to U.S. Provisional Patent Application No. 61/936,378, filed on Feb. 6, 2014, which is incorporated herein by reference in its entirety.

### FIELD OF TECHNOLOGY

The present description relates to methods and systems for linking to a shared library and more particularly, for linking secure applications to a shared library, such as a shared class library.

### BACKGROUND

In an effort to increase productivity, many employers allow their workers to conduct business related to the employer on their personal mobile devices. In some cases, employers also provide some of their employees with company-issued mobile devices. In either arrangement, an employer understands that a single device may include sensitive data related to that employer in addition to data that is personal to the employee. Several advances have been made in an effort to protect an employer's data in these circumstances. For example, OpenPeak Inc. of Boca Raton, Florida has developed solutions that enable a mobile device to include both enterprise and personal data but that isolate the enterprise data from the personal data. As part of these solutions, an employee may download secure applications that may be used to conduct transactions related to the enterprise, but these secure applications are prevented from exchanging data with conventional or non-secure applications.

These secure applications are typically altered to enable management of the applications and for security purposes, a process sometimes referred to as “wrapping” or “adapting” the application. In certain cases, an application is wrapped by manipulating the binary of the application and inserting adaptive code in the application to enable the interception of calls to and from the application. This process can increase the functionality of the application and can make it secure, as described above.

### SUMMARY

A method of linking to a shared library, such as a shared class library, is described herein. The method can include the step of launching an application on a computing device in which the computing device can support a first class loader and a second class loader. The first class loader may serve as a parent class loader to the second class loader. In response to the launching of the application, an override class loader that is configured to serve as an override parent class loader to the second class loader can be generated and integrated into the existing class loading hierarchy. When a request for a component is received from the launched application at the second class loader, the request can be intercepted by the override class loader to determine if the override class loader is to process the request. If the override class loader is to process the request, the override class loader can be used to search the shared library for the component. If it is determined that the override class loader is to not process the request, however, the request can be delegated from the override class loader to the first class loader.

The method can also include the steps of loading a core application on the computing device in which the core application may include one or more shared libraries. The shared libraries can be stored in a repository of the computing device. The method can also include the step of associating the shared libraries in the repository with the override class loader.

In one arrangement, the launched application can be a secure application, and the request for the component from the secure application may be for one or more classes that are part of the shared library. In another arrangement, the launched application is unaware of the override class loader such that the requests that the launched application would normally make to the second class loader are unaffected by the generation of the override class loader.

As another example, generating the override class loader can include changing the parent class loader of the second class loader from the first class loader to the override class loader. Generating the override class loader may also include setting the first class loader as the parent of the override class loader with selective delegation.

Another method of linking to a shared library is described herein. The method can include the step of generating an override class loader that is associated with one or more shared libraries. Calls from an application can be intercepted by the override class loader in which the calls would normally be passed to a first class loader from a second class loader. The calls from the application can be selectively processed by the override class loader, and the application is unaware of the override class loader such that the calls from the application to the second class loader are unaffected. As an example, the application can be a secure application, and the secure application can include instructions for generating the override class loader. The method can also include the step of installing the shared libraries from a core application.

A computing device is also described herein. The computing device can include a repository that is configured to store one or more shared libraries that may be used by one or more applications installed on the computing device. Moreover, the computing device can include a processing unit that may be configured to interact with a virtual machine to cause certain actions to take place. For example, the processing unit—in conjunction with the virtual machine and any other relevant components or modules—can cause an application to be launched and displayed on the computing device in which the virtual machine supports a first class loader and a second class loader and can cause an override class loader to be generated in response to the launching of the application. The override class loader can be configured to serve as a parent class loader to the second class loader. This combination can also cause the override class loader to intercept a request for a component from the application when the request is received from the application at the second class loader to determine if the override class loader is to process the request. The combination can also cause the override class loader to search the shared libraries in the repository for the requested component.

The computing device can also include an interface that can be configured to receive the application and a core application. In one arrangement, the core application can include the shared libraries that are stored in the repository. In another arrangement, the applications installed on the computing device may be secure applications, and the secure applications can include instructions to generate the override class loader.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for the distribution of applications to computing devices.

FIG. 2 illustrates an example of a block diagram of the system architecture of a computing device.

FIG. 3 illustrates an example of a method for linking to a shared library.

FIG. 4 illustrates an example of an arrangement of class loaders.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The term “among,” as it is used throughout this description, should not necessarily be interpreted as requiring exchanges or interaction among three or more applications, irrespective of grammar rules.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged (directly or indirectly) between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The term “non-transitory computer readable storage medium” is defined as one or more non-transitory components that are configured to store instructions that are to be executed by one or more processing units.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The terms “memory,” “memory element” or “repository” are defined as one or more components that are configured to store data, either on a temporary or persistent basis. The term “shared memory” is memory, a memory element or a repository that is accessible (directly or indirectly) by two or more applications or other processes. An “interface” is defined as a component or a group of components that enable(s) a device to communicate with one or more different devices, whether through hard-wired connections, wireless connections or a combination of both.

The term “file system” is defined as an abstraction that is used to organize, store and retrieve data. The term “secure application” is defined as an application that has been modified or enhanced from its original form to restrict communications between the application and unauthorized programs, applications or devices and to restrict operation of the application based on policy or to alter, augment or add features associated with the operation of the application (or any combination thereof) or—in the case of the application not being modified or enhanced—an application that is part of a secure workspace that is protected from data exchanges with applications that are part of a personal or an unsecure workspace. A “target application” is defined as an application that has been selected for conversion into a secure application.

A “class loader” or “component loader” is defined as a component, module or object that loads classes or components into a virtual machine. An “override class loader” or “override component loader” is defined as a class loader or component loader that, when generated, intercepts and selectively overrides requests for certain components that would normally be directed to a parent class loader (or parent component loader) from a child class loader (or child component loader). A “shared library” is defined as a collection of files that may be accessed or used by multiple applications, programs or other objects. A “shared class library” is defined as a collection of classes that may be accessed or used by multiple applications, programs or other objects through a virtual machine. The term “core application” is an application that contains one or more shared libraries that are to be stored in a repository of a computing device on which the core application is installed or in a repository at a remote location. A “virtual machine” is defined as a platform-independent execution environment that emulates a physical machine.

As explained earlier, solutions have been developed to enable employees of an enterprise to carry mobile devices that include both enterprise and personal data, with the enterprise data being isolated from the personal data. As part of these solutions, one or more secure applications may be installed on an employee's mobile device Improving the operation of these secure applications is an important factor in achieving widespread distribution of such programs.

As part of a solution, a method and system for linking to a shared library are described herein. In particular, an application, such as a secure application, may be launched on a computing device in which the computing device may support a first class loader and a second class loader. In one embodiment, the first class loader can serve as a parent class loader to the second class loader. In response to the launching of the application, an override class loader that is configured to serve as an override parent class loader to the second class loader can be generated. When a request for a component is received from the launched application at the second class loader, the request can be intercepted by the override class loader to determine if the override class loader is to process the request. If the override class loader is to process the request, the override class loader can be used to search the shared library for the component.

Through this arrangement, a significant part of the adaptive code that would normally be integrated with a secure application can be packaged as part of a shared library. In addition, the override class loader can parse through requests from the secure applications to selectively handle them, which can ensure that certain predefined components from the shared library are made available to the secure applications, as opposed to some system components that may cause issues with the operation of the secure applications. Moreover, the secure applications are not required to be aware of the override class loader or to distinguish between requests for components of the shared library and the (conventional) components of the system.

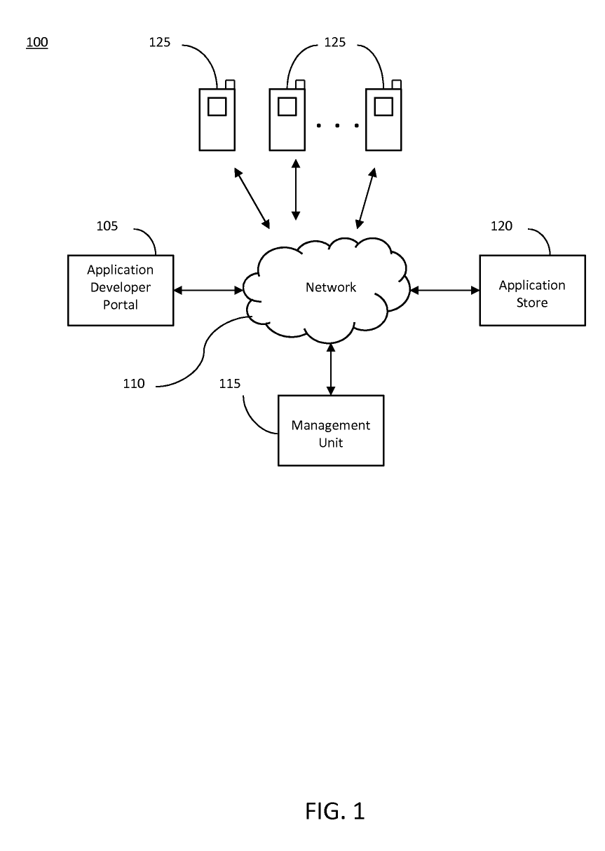

Referring to FIG. 1, a system 100 that is useful for distributing applications is shown. In one arrangement, the system 100 can include an application developer portal 105, a network 110, a management unit 115, an application store or repository 120 and any number of computing devices 125. Although not shown here, the system 100 can include multiple application developer portals 105, networks 110, management units 115 or application stores 120. Also, while FIG. 1 implies that the computing device 125 is a mobile unit, the system 100 and the processes described herein may be relevant to and practiced with fixed computing devices.

The application developer portal 105 can present an interface that enables developers of applications to upload their applications for eventual publication in the application store 120. The application store 120, as is known in the art, can enable users of the portable computing devices 125 to install such published applications on their devices 125. In some cases, the applications from the application developers may be directed to the management unit 115 prior to being published in the application store 120. Through the management unit 115, the applications may be modified such that they are more conducive for operation on behalf of an enterprise or other organization. For example, the applications may be converted into secure or wrapped applications, a process in which certain functions of the application may be restricted, enhanced or otherwise modified in some way, depending on input from the enterprise. Examples of this process are known in the art, and additional information may be obtained from U.S. Pat. No. 8,695,060, issued on Apr. 8, 2014; U.S. Patent Application Publication No. 2014/0096230, filed on Sep. 25, 2013; U.S. patent application Ser. No. 14/205,661, filed on Mar. 12, 2014; U.S. patent application Ser. No. 14/205,686, filed on Mar. 12, 2014; and U.S. Patent Application No. 62/033,142, filed on Aug. 5, 2014, each of which is herein incorporated by reference in its entirety.

Once a secure application is generated, it can be published in the application store 120, similar to a conventional application that has been published. An application that has been selected for conversion into a secure application by the management unit 115 (or some other component) may be referred to as a target application. Although described in terms of secure applications, the system 100 may also be suitable for distributing conventional (i.e., non-secure) applications. Moreover, the applications that are made available through the application store 120 are not necessarily required to be received from the application developer portal 105, as other sources may be used to provide applications to the application store 120.

The network 110 can facilitate communications between any of the components of the system 100. As mentioned earlier, there may be multiple networks 110 in the system 100, and each network 110 may be composed of various types of components to support wireless or wired communications (including both). In addition, the network(s) 110 may be configured to support local or wide area communications (or both).

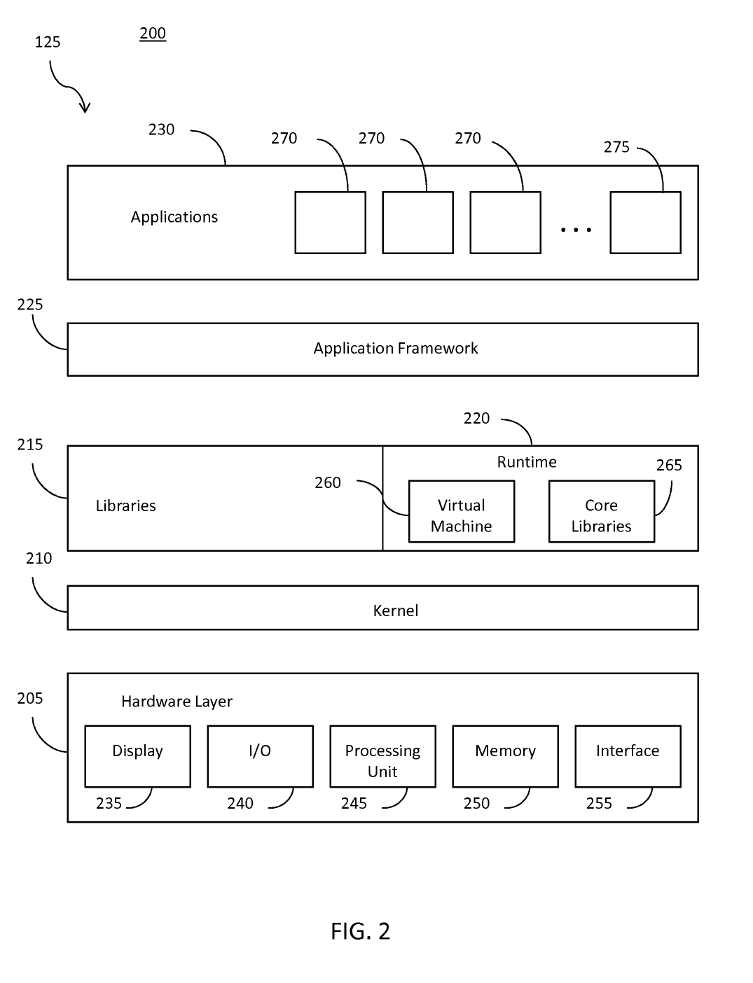

Referring to FIG. 2, an example of a block diagram 200 of the system architecture of a computing device 125 is shown. In this arrangement, the computing device 125 can include a hardware layer 205, a kernel layer 210 and a libraries layer 215, which may include a plurality of native libraries. This architecture may also include a runtime environment 220, an application framework layer 225 and an application layer 230.

In one arrangement, the hardware layer 205 may include one or more displays 235, one or more input/output (I/O) devices 240, one or more processing units 245 and any suitable type and number of memory components 250 and interfaces 255. Examples of I/O devices include speakers, microphones, physical keypads, etc. The interfaces 255 can be configured to support various types of communications, including wired or wireless and through any suitable type of standards and protocols.

In addition, the runtime environment can support any suitable number of virtual machines 260 and core libraries 265, and the application layer 230 can include any suitable number of applications 270. As referenced earlier, at least some of the applications 270 may be secure applications. As part of this arrangement, a core application 275 may also be installed on the computing device 125. As is known in the art, the application framework 225 may provide abstractions to the applications 270 for the underlying layers, such as for the native libraries of the libraries layer 215 and the virtual machine 260 of the runtime environment. As part of this arrangement, the application framework layer 225 may be a secure framework layer that is designed to accommodate secure applications. Significantly, the description herein may be practiced with other system architectures and is not limited to that shown in FIG. 2.

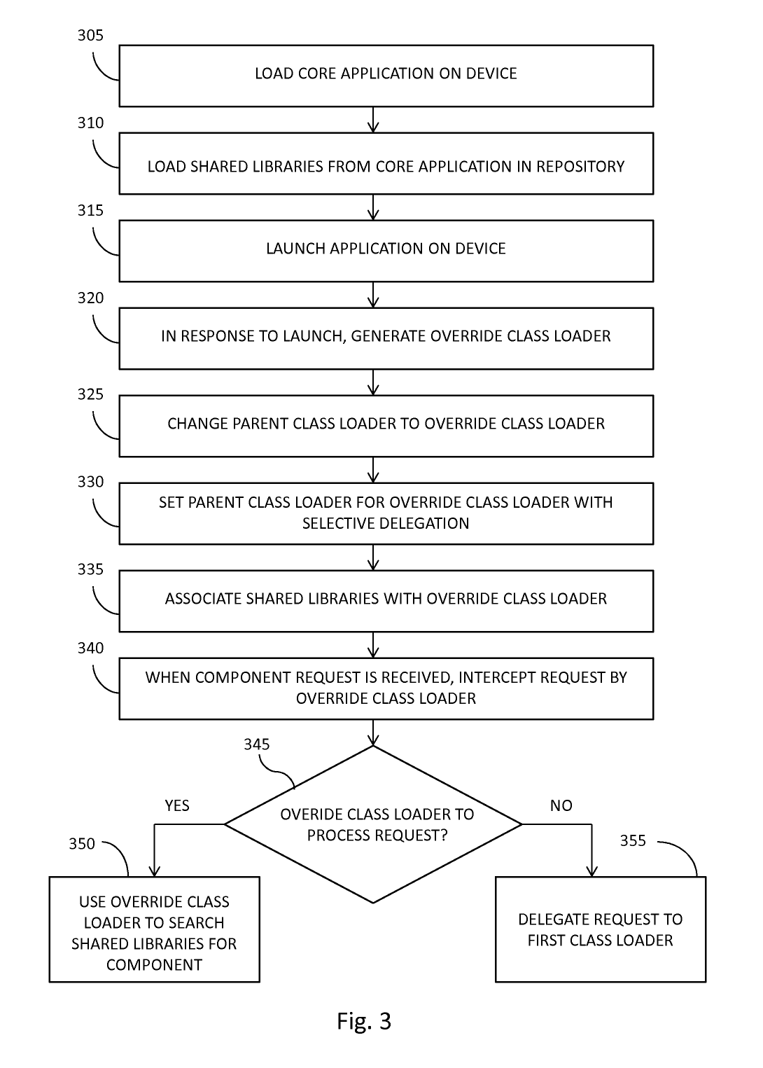

Referring to FIG. 3, an exemplary method 300 for linking to a shared library is illustrated. The method 300, however, may include additional or even fewer steps or processes in comparison to what is illustrated in FIG. 3. Moreover, the method 300 is not necessarily limited to the chronological order that is shown in FIG. 3. In describing the method 300, reference may be made to FIGS. 1, 2 and 4, although it is understood that the method 300 may be practiced with any other suitable systems and components and may take advantage of other suitable processes.

At step 305, a core application can be loaded or installed on a computing device in which the core application may contain one or more shared libraries. At step 310, the shared libraries can be loaded in a repository on the computing device.

For example, a core application 275 may be received by the interface 255 and can be installed on the computing device 125. In one arrangement, the core application 275 may be a secure application and may include any number of files that can make up any number of shared libraries. In one particular but non-limiting example, the core application 275 may include an assets folder that contains a number of Java Archive (JAR) files, and when the core application 275 is loaded, these JAR files can be copied to an appropriate repository of the computing device 125. As such, the core application 275 can be responsible for providing a certain number of classes that can make up the shared libraries, which can be made available to the secure applications 270. These classes, as will be explained below, can be substituted for certain system classes that would be normally be used.

Referring back to the method 300 of FIG. 3, at step 315, an application can be launched on the computing device, and the computing device can support a first class loader and a second class loader in which the first class loader serves as a parent class loader to the second class loader. In response to the launching of the application, an override class loader that is configured to serve as an override parent class loader to the second class loader can be generated, as shown at step 320. As such, as part of generating the override class loader, the parent class loader of the second class loader can be changed from the first class loader to the override class loader, as shown at step 325. Additionally, at step 330, the first class loader can be set as the parent of the override class loader with selective delegation. At step 335, one or more of the shared libraries in the repositories may be associated with the override class loader.

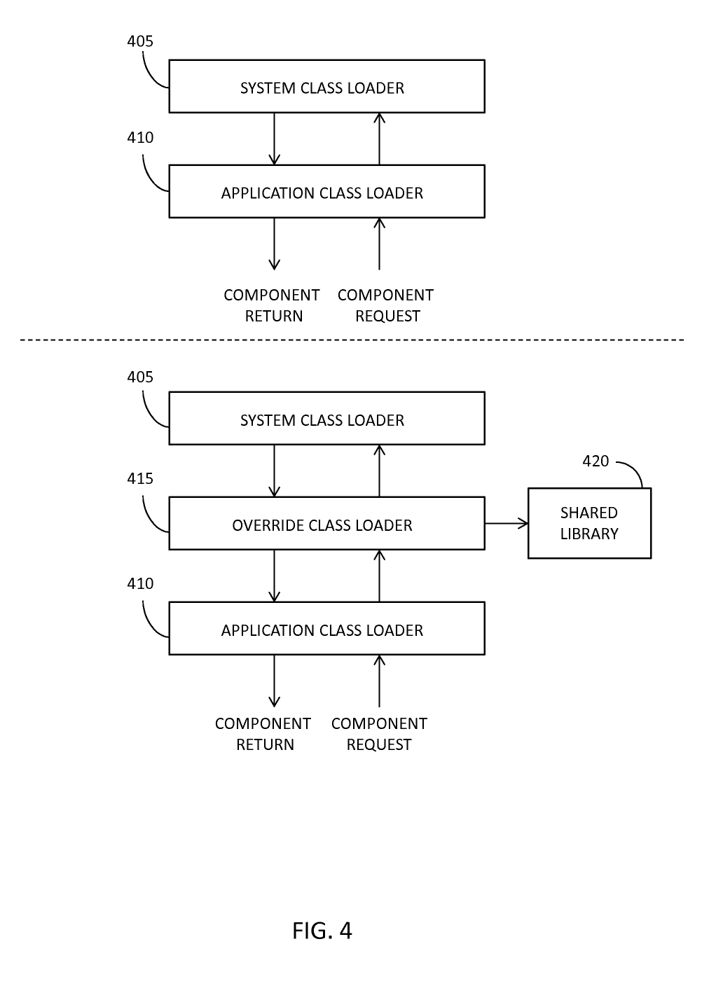

As previously noted, any number of applications 270 may be installed on the computing device 125, and some of the applications 270 may be secure applications 270. In one embodiment, the secure applications 270 may contain adaptive code that can cause an override class loader to be generated, such as when the secure application 270 is launched. To assist in the explanation of this process, reference will be made to FIG. 4.

The top part of FIG. 4 shows a conventional arrangement that includes a system class loader 405 and an application class loader 410. A class loader, as is well understood, can convert a reference to a named class into the code responsible for implementing that class. In this case, the system class loader 405 is the parent of the application class loader 410, which may be referred to as a child class loader. As is known in the art, when a request for a component, such as a call for a class, is received at the application class loader 410, the application class loader 410 can delegate this request to the system class loader 405, if the requested component has not already been loaded. At this point, the system class loader 405 searches for the requested component in its assigned repository, and returns the requested component. If the system class loader 405 is unable to return the component, the application class loader 410 may search for the component in its associated repository and if available, can load the component. The returned components may also be cached for efficiency.

Referring to the lower section of FIG. 4, when a secure application 270 is launched, an override class loader 415 may be generated. In this case, the application class loader 410 may be associated with the original target application, and the system class loader 405 may be tied to the operating system of the computing device 125. In one arrangement, as part of this process, the parent of the application class loader 410 can be changed from the system class loader 405 to the override class loader 415. That is, the override class loader 415 can be integrated into an existing class loading hierarchy. As such, when the application class loader 410 receives a request for a component, the application class loader 410 can delegate the request to the override class loader 415. In addition, the system class loader 405 can be set as the parent to the override class loader 415. In this instance, however, the override class loader 415 can contain logic that can enable it to selectively delegate component requests to the system class loader 405, a process that will be explained below. This process of implementing the override class loader 415 into the arrangement of the system class loader 405 (i.e., parent class loader) and the application class loader 410 (i.e., child class loader) and resetting their dependencies or relationships may be referred to as daisy-chaining class loaders.

When the override class loader 415 is generated, one or more shared libraries 420 can be associated with the override class loader 415. These shared libraries 420 can be those that are created from the loading of the core application 275, a process that was previously described. As part of this arrangement, one or more class paths or component paths can be created for directing the override class loader 415 to the appropriate repositories. The override class loader 415 can search these shared libraries 420 for component requests from any number of secure applications 270.

Referring once again to the method 300 of FIG. 3, at step 340, when a request for a component is received from the launched application at the second class loader, the request can be intercepted by the override class loader to determine if the override class loader is to process the request. At decision block 345, a determination can be made as to whether the override class loader is to process the request. If yes, then the override class loader can be used to search the shared library for the component, as shown at step 350. If no, the override class loader can delegate the request to the first (or parent) class loader, as shown at step 355.

For example, the secure application 270 can generate one or more requests for components, and the application class loader 410 can receive these requests and delegate them to the override class loader 415. In response, the override class loader 415 can parse or analyze the requests from the application class loader 410, and the override class loader 415 can be configured to process certain requests. If the override class loader 415 determines that it is to handle a certain request, the override class loader 415 can search for the component in one or more of the shared libraries 420 and can return the component to the application class loader 410 for loading and eventual use by the requesting secure application 270. For example, if the override class loader 415 determines that the request is for a reference to a class that is not part of the base operating system application programming interfaces (API), the override class loader 415 can load the requested reference from a well-known location where the override extensions or components are kept. As such, the override class loader 415 can enable the use of certain components in place of equivalent system components.

Consider the following example. In some environments, a certain class in the conventional system framework is referred to as contactscontract, which lays out the structure of the contacts database. As is known in the art, the contacts database may include data relating to a user's contacts, such as phone numbers and email addresses. In addition, a computing device 125 that supports secure applications 270 may contain a contacts database that is also secure and is separate and distinct from the conventional contacts database of the device 125. In some cases, a manufacturer of a computing device may make changes to the contactscontract class, such as by incorporating additional fields. Because the secure applications 270 may be based on a secure (and different) framework, the contactscontract class of the system may not align with a secure contacts database. As such, this potential misalignment may cause issues with the operation of the secure application 270.

The override class loader 415, however, can receive this call and can determine that it should handle the request, as opposed to the system class loader 405. Accordingly, the override class loader 415 can search the shared library 420 for the appropriate class that is equivalent to the system class and can return this class to the application class loader 410.

Thus, the description herein enables certain requests to be intercepted and satisfied with equivalent components that are geared towards secure applications or other programs that may require modifications to system components to ensure proper operation. In addition, the requesting applications are not required to be aware of the override class loader 415 or that the requested component may need to be satisfied with an equivalent component, as opposed to a conventional system component. That is, the logic of distinguishing between system components and equivalent components in the shared libraries 420 is not required to be part of the application, as the override class loader 415 can be responsible for this process. Because of this arrangement, the requests that the secure application 270 would normally make to the application class loader 410 are unaffected by the generation and use of the override class loader 415. In addition, this scheme is useful in certain operating environments that do not permit or otherwise would not normally allow a class that is part of the framework to be overridden.

Moreover, the use of the shared libraries 420 reduces the amount of adaptive code that is required to be part of a secure application 270, as the secure applications 270 can simply access many of their new, enhanced or modified functionalities through the services offered by the shared libraries 420. If an update is required, one or more of the shared libraries 420 can simply be updated, as opposed to re-adapting and re-distributing the secure applications 270 on an individual or group basis. Moving forward, the secure applications 270 may then rely on the updated shared libraries 420.

If the override class loader 415 determines that it is not responsible for handling the request, the override class loader 415 can simply delegate that request to its parent class loader, in this case, the system class loader 405. For example, the component that is requested may be a system component that is acceptable for the requesting application 270, and this request can be processed as it normally would.

Although the term “class loader” is used through this document, the description herein is not necessarily limited to the loading of classes. In particular, the arrangements herein may be practiced in any suitable environment, and any suitable type of component may be pulled from a shared library in support of an application. Moreover, the description herein is not necessarily limited to use with secure applications or computing devices with secure frameworks, as conventional applications and devices may take advantage of these embodiments.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of linking to a shared library, comprising:
launching an application on a computing device, wherein the computing device supports a first class loader and a second class loader and the first class loader serves as a parent class loader to the second class loader;
in response to the launching of the application, generating an override class loader that is configured to serve as an override parent class loader to the second class loader;
when a request for a component is received from the launched application at the second class loader, intercepting the request by the override class loader to determine if the override class loader is to process the request; and
if the override class loader is to process the request, using the override class loader to search the shared library for the component.

2. The method according to claim 1, wherein if it is determined that the override class loader is to not process the request, delegating the request from the override class loader to the first class loader.

3. The method according to claim 1, further comprising:
loading a core application on the computing device, wherein the core application includes one or more shared libraries; and
loading the shared libraries in a repository of the computing device.

4. The method according to claim 3, further comprising associating the shared libraries in the repository with the override class loader.

5. The method according to claim 1, wherein the launched application is a secure application and the request for the component from the secure application is for one or more classes that are part of the shared library.

6. The method according to claim 1, wherein the launched application is unaware of the override class loader such that the requests that the launched application would normally make to the second class loader are unaffected by the generation of the override class loader.

7. The method according to claim 1, wherein generating the override class loader includes changing the parent class loader of the second class loader from the first class loader to the override class loader.

8. The method according to claim 7, wherein generating the override class loader also includes setting the first class loader as the parent of the override class loader with selective delegation.

9. A method of linking to a shared library, comprising:
generating an override class loader that is associated with one or more shared libraries;
intercepting calls from an application by the override class loader, wherein the calls would normally be passed to a first class loader from a second class loader; and
selectively processing the calls from the application by the override class loader, wherein the application is unaware of the override class loader such that the calls from the application to the second class loader are unaffected.

10. The method according to claim 9, wherein the application is a secure application, and the secure application includes instructions for generating the override class loader.

11. The method according to claim 9, further comprising installing the shared libraries from a core application.

12. The method according to claim 9, wherein the first class loader is a system class loader and the second class loader is an application class loader.

13. The method according to claim 12, further comprising setting the override class loader as a parent class loader of the application class loader and the system class loader as a parent class loader of the override class loader.

14. The method according to claim 12, wherein the application class loader is a class loader that is associated with a target application that is converted into a secure application.

15. The method according to claim 14, further comprising updating the shared libraries instead of updating the secure application.

16. The method according to claim 9, wherein selectively processing the calls from the application by the override class loader comprises:
searching the shared libraries for components in response to the calls from the application; and
retrieving the components from the shared libraries, wherein the components are equivalent to one or more system components.

17. A computing device, comprising:
a repository that is configured to store one or more shared libraries that may be used by one or more applications installed on the computing device;
a processing unit, wherein the processing unit is configured to interact with a virtual machine to cause:
an application to be launched and displayed on the computing device, wherein the virtual machine supports a first class loader and a second class loader;
an override class loader to be generated in response to the launching of the application, wherein the override class loader is configured to serve as a parent class loader to the second class loader;
the override class loader to intercept a request for a component from the application when the request is received from the application at the second class loader to determine if the override class loader is to process the request; and
the override class loader to search the shared libraries in the repository for the requested component.

18. The computing device according to claim 17, further comprising an interface that is configured to receive the application and a core application, wherein the core application includes the shared libraries that are stored in the repository.

19. The computing device according to claim 17, wherein the applications installed on the computing device are secure applications and the secure applications include instructions to generate the override class loader.

20. The computing device according to claim 19, wherein the application class loader is associated with a target application that has been converted into one of the secure applications.

21. The computing device according to claim 17, wherein the processing unit is further configured to cause the shared libraries to be updated with instructions such that the secure applications are not required to be updated with the instructions.

22. The computing device according to claim 17, wherein the processing unit is further configured to cause the requested component to be returned to the second class loader, wherein the returned component is an equivalent to a system component.

23. The computing device according to claim 17, wherein the request for the component from the application is a normal call to the second class loader such that the generation of the override class loader does cause the application to alter the call to the second class loader.
